(19) United States
(12) Patent Application Publication
(10) Pub. No.: US 2026/0317051 A1
(43) Pub. Date: Oct. 15, 2026

(54) CAPSULE, SYSTEM AND METHOD FOR DELIVERING A FILTER-LIKE COFFEE EXTRACT

(71) Applicant: SOCIÉTÉ DES PRODUITS NESTLÉ S.A., Vevey (CH)

(72) Inventors: Philippe KESSLER, Saint-Aubin (CH); Jose Javier ALVAREZ BACHA CRUZ, Lausanne (CH); Alexis Alberto RODRIGUEZ RODRIGUEZ, Epalinges (CH); Frédéric MESTDAGH, Lausanne 26 (CH); Arnaud GERBAULET, Oye et Pallet (FR); Veith BEHRMANN, Villeneuve (CH); Cedric RICHARD, Poliez-Pittet (CH); Cécile DELIGNY, Orbe (CH); David BATTISTOLO, Pontarlier (FR)

(21) Appl. No.: 19/114,624

(22) PCT Filed: Sep. 22, 2023
(86) PCT No.: PCT/EP2023/076167

§ 371 Date: Mar. 24, 2025

(30) Foreign Application Priority Data
Sep. 28, 2022 (EP) 22198480.0

(51) Int. Cl. B65D 85/804; A23F 5/26; A47J 31/06; A47J 31/34

(52) U.S. Cl. CPC B65D 85/8061; A23F 5/262; A47J 31/0642; A47J 31/34

(57) ABSTRACT

The invention concerns a capsule for preparing a filter-type coffee extract comprising a substantially rigid capsule body having a circumferential sidewall extending around an inner space of the capsule, a base wall covering the inner space at a first end of the sidewall, a flange arranged circumferentially at a second end of the sidewall of the base body, a lid removably attached to the flange and covering the inner space at a second end of the sidewall opposite the base wall and tightly closing the capsule, and a filter element positioned in the inner space of the capsule between the beverage ingredient and the lid in which the inner space of the capsule is at least partially filled with ground coffee, preferably roast and ground coffee, having a particle size distribution D4,3 of 500 microns+/−30 microns and a fraction of fine particles between 2 and 9% of the roast and ground coffee. The invention also relates to a system comprising said capsule, to the use of said capsule or system and to a method for delivering a filter-like coffee extract.

### FIELD OF THE INVENTION

The invention relates to a capsule designed to be extracted in a beverage preparation machine and containing a substance for the preparation of a filter-like coffee beverage.

The invention is also directed to related system integrating the innovative capsule, to the use of such capsule and/or system and to a method using the innovative capsule.

### BACKGROUND

Coffee cups can be produced from filter coffee machines. However, as a result of a “light” extraction of the coffee, the resulting extract usually has low coffee solids concentration, a low aroma profile, and little or no “crema” on the top.

Capsules designed to be extracted under pressure and containing a substance for the preparation of a beverage have been developed and are now widely used. They provide a better extraction of coffee, i.e., a higher “extraction yield”, more aroma and a “crema”, more convenience in operation and they ensure freshness of the substance contained therein. As a result, the delivery of freshly extracted beverages of constant quality is better ensured.

For instance, the actual system commercialized under the trademark “Nespresso®” is appreciated for producing good quality short cups of coffee and long cups of coffee. A short cup of coffee is defined as containing less than 50 grams of coffee liquid extract in the cup and more specifically about 40 g for the espresso type and about 25 g for the Ristretto type. Due to the high-pressure extraction conditions maintained in the capsule, in the order of 10-20 bar, the liquid extract which is delivered can be given desirable quality attributes in terms of coffee yield, coffee solids and “crema” and within a delivery flow time which is found acceptable for the user.

In view of the premium coffee produced with this system, many consumers have equipped themselves with a Nespresso® machine.

Some consumers, however, prefer to have the option to also prepare a cup of coffee having all the attributes of a filter-like coffee with the same machine.

It is then desirable to propose a capsule having adapted structure and coffee recipes that could be extracted in a conventional Nespresso® to obtain a filter-like coffee having all the attributes required by the consumer in an acceptable delivery time (for example, a delivery time which exceeds one minute is unacceptable on a commercial standpoint and inconvenient to the consumer who wants to prepare several cups in a row).

### SUMMARY OF THE INVENTION

In this respect, the invention proposes a capsule for preparing a filter-type coffee extract according to claim 1.

In more details, the proposed capsule comprises a substantially rigid capsule body having a circumferential sidewall extending around an inner space of the capsule, a base wall covering the inner space at a first end of the sidewall, a flange arranged circumferentially at a second end of the sidewall of the base body, a lid removably attached to the flange and covering the inner space at a second end of the sidewall opposite the base wall and tightly closing the capsule, and a filter element positioned in the inner space of the capsule between the beverage ingredient and the lid. Particularly, the inner space of the capsule is, at least partially, filled with ground coffee, preferably roast and ground coffee, having a particle size distribution D4,3 of 500 microns+/−30 microns and a fraction of fine particles between 2 and 9% of the roast and ground coffee.

According to one important aspect of the invention, the capsule is filled with roast and ground coffee of controlled particle size and reduced level of fines.

The particle size distribution of the proposed coffee is higher than the one usually used in the coffee capsules on the market. The selected granulometry of the ground coffee presents big or coarse particles and ensures a smooth extraction with low coffee bed resistance and pressure in the capsule. The surface of contact between the extraction fluid and the coffee particles is thus optimized for the creation of a filter-type coffee extract having light and fruity aromas.

A control of the percentage of fines in the coffee bed plays a key role in the reduction of the pressure loss in the coffee bed while maintaining the desired coffee extraction level. The invention is also based on the principle of reducing the level of fines in the ground coffee; such level of fines providing a faster flow while not significantly affecting the extraction yield of the resulting coffee extract.

More particularly, the fine particles have an average diameter of less than 50 microns.

In the proposed capsule considering its specific construction, the roast and ground coffee inside the capsule is in an amount between 4 and 5.5 grams. The amount of coffee is chosen to allow the coffee to remain loose inside the capsule without exercising any pressure on the filter and carrier disk.

In addition, the roast and ground coffee in the capsule has a density between 380 and 450 g/l to ensure that sufficient concentration of aromas is present and to allow the resulting coffee extract to contain the required sensory characteristics of a filter-type coffee extract.

According to the invention, the coffee extract is delivered in a flow time of less than 40 s for a coffee extract volume of 150 ml.

The proposed grind with a reduced level of fines enables controlling the flow time for filter-like coffee extract. In particular, a flow time of between 30 and 40 seconds can be successfully obtained, which is an acceptable flow time for a consumer. The flow time is intended as extraction time without any relaunch time between potentially needed subsequent extractions.

According to a further feature, the roast and ground coffee inside the capsule is extracted at a pressure between 2 and 6 bars.

Because of the capsule is not closed as the lid 5 is removed before being used in the beverage preparation device, the extraction pressure building up inside the capsule is limited. The controlled extraction pressure allows s limited formation of foam and crema during extraction which is one of the attributes of filter-like coffee.

According to a further feature, the capsule has an internal pressure between 5 and 100 mb before being used.

In the proposed innovation, the capsule comprises a carrier disk comprising multiple preformed outlets opening. The carrier disk is provided between the lid and the filter and ensures that the filter is retained in the capsule. The carrier disk also allows the production of a coffee extract with little or no crema.

In a particular embodiment, the carrier disk comprises between 50 and 150 outlet openings and an open surface ratio of the carrier disk that is higher than 4% to allow sufficient pressure in the capsule for the coffee extraction as well as to enable sufficient flowing of the coffee extract outside the capsule.

In a proposed embodiment, the filter element is or is made from a non-woven material having a porosity between 600 and 2500 l/m2/s according to ISO 9237. The filter is adapted to retain fines inside the capsule and to reduce the formation of a crema layer.

As an additional advantage, the filter element retains lipid fraction, preferably oils, from the coffee, before supplying the coffee to a container.

Thanks to the proposed design of the capsule and characteristics of the coffee, the total solids (TC) in the resulting coffee extract is below 1.5% and preferably comprised between 0.3 and 0.9%.

The extraction yield of the resulting filter-type coffee extract (150 ml approximately, for approximately 5 to 5.3 grams of coffee) is comprised between 15 and 30%, more preferably between 17 and 28%, most preferably 18 and 22%, which is particularly satisfactory considering the quantity of coffee inside the capsule and the low extraction pressure.

The amount of total solids in the cup must be sufficient to confer sufficient body and texture to the beverage but as well should correspond to the expectation of a filter-like coffee to find consumer acceptance. Therefore, although it may also be a matter of preference, the best concentration of total solids for a filter-like coffee for an extraction in the proposed capsule has been determined to be below 1.5. Proper extraction yields and total solids can be obtained with capsules containing about 4 and 5.5 g.

The present invention relates to a system that uses capsules and their attached benefits, to provide filter-type coffee beverages. The system of the invention aims at preparing a filter-type coffee beverage. It comprises an exchangeable capsule according to the invention and a beverage preparation machine with a fluid dispensing device capable of feeding an amount of a fluid, such as water, with a pressure between 0.1 bar and 20 bar to the capsule, and with a brewing chamber, wherein a filter-type coffee extract volume of 150 ml is obtained by a double extraction using the same capsule. The double extraction may comprise first extracting a lungo coffee extract and second extracting an espresso coffee extract or may comprise first extracting an espresso coffee extract and second extracting a lungo coffee extract. In any case, the filter-type coffee extract is delivered in a flow time of less than 40 s. The flow time of less than 40 s is intended without the relaunch time between the two extractions.

The extraction may also be obtained using a single extraction of 150 ml when the beverage preparation machine allows it.

Thanks to the proposed system, it is possible to prepare a filter-type coffee extract using a conventional Nespresso® machine in a limited time.

The invention is further directed to the use of a capsule presenting one or more of the above disclosed features alone or in a system presenting one or more of the above disclosed features.

Furthermore, the invention provides a method for delivering a filter-like coffee extract from a capsule presenting one or more of the above disclosed features suitable for preparing a beverage as claimed.

In said delivering method, the capsule has a circumferential sidewall and a base wall defining together an inner space, and a removable lid closing the capsule at its opening side. The inner space of the capsule is filled with a beverage ingredient such as roast and ground coffee and said inner space hosts both a filter element positioned in the inner space of the capsule between the beverage ingredient and the lid; and a carrier disk comprising multiple preformed outlets openings, said carrier disk being provided between the lid and the filter element. In the delivering method, the capsule, after removal of the lid, is inserted into and extracted by the beverage preparation machine; the coffee extract is released through the filter element and carrier disk with reduced engagement with engaging means of the beverage preparation machine in comparison of capsule comprising a non-removal lid; and the coffee extract is extracted at pressure between 2 and 6 bars.

In particular, during extraction, the pressure loss in the coffee bed is reduced by providing, in the capsule, roast and ground coffee having a particle size distribution D4,3 of 500 microns+/−30 microns and a fraction of fine particles between 2 and 9% of the roast and ground coffee:

Specific embodiments of the invention are described in the following detailed description. The objects are achieved by the present invention, i.e. a capsule, a system, the use and a method for delivering filter-like coffee extract.

### BRIEF DESCRIPTION OF THE DRAWINGS

The invention is further described with reference to the following examples. It will be appreciated that the invention as claimed is not intended to be limited in any way by these examples.

Embodiments of the present invention will now be described, by way of examples, with reference to the accompanying figures in which:

FIG. 1A is a perspective side view of a capsule tightly closed before use in a beverage preparation device, according to the invention;

FIG. 1B is a perspective side view of a capsule in which the lid is partially removed, according to the invention;

FIG. 1C is a perspective side view of a capsule in which the lid has been removed and ready to be used in a beverage preparation device, according to the invention;

FIG. 2A is a schematic cross-sectional view of a capsule according to a first embodiment of the invention;

FIG. 2B is an enlarged view of an identified bottom portion of the capsule of FIG. 2A;

FIG. 2C is a view of the carrier disk of the capsule of FIG. 2A before being assembled in the capsule;

FIG. 3 is a graphic showing the Particle Size Distribution of the coffee of the capsule of the invention compared to the particle size distribution of two commercial coffees proposed in conventional Nespresso® capsules;

FIG. 4 is a table showing the Total Solids (TC) and Extraction Yield values obtained for the filter-like coffee extract of the capsule of the invention compared to long-cup coffee extracts of two commercial Nespresso® coffee capsules;

FIGS. 5A to 5C are graphics showing the average evolution of the extraction pressure for two capsules of the invention and a conventional Nespresso® capsule.

### DETAILED DESCRIPTION

In the present application, terms are utilized for which the definitions are given as a preamble below.

The “extraction yield” is defined as the weight of total solids in the liquid extract divided by the total weight of starting coffee ingredients in the capsule (e.g., roast and ground coffee). This value is typically expressed as a percentage. The extraction yield is representative of the strength of the coffee extract and depends on the quantity of coffee and total volume of extracted coffee.

The “total solids (Tc)” is defined as the weight of extracted solids contained in the extract divided by the total weight of the extract. This value is typically expressed as a percentage.

The “injection pressure” is defined as the maximal pressure expressed in bar and measured at the injection point(s) in the capsule during extraction.

The “flow time” is defined as the time from the first moment of fluid dropping into the coffee cup to the moment the extract has been delivered into the cup with the desired weight, strength and aroma.

“Espresso coffee extract” (also called Expresso coffee extract) is defined as the liquid extract as obtained from the capsule with a weight of about 40 g (+/−10 g).

“Long coffee extract” is defined as the liquid extract as obtained from the capsule with a weight of about 110 g (+/−10 g).

“Filter coffee extract” or “filter-like coffee extract” is defined as the liquid extract as obtained from the capsule with a weight of about 150 g (+/−10 g).

A “filter-type coffee” is defined according to its sensory profile as a smooth and easy to drink coffee characterized by little crema, quickly disappearing (in less than 1 or 2 mins) or even an absence of crema and by the absence of harsh or bitter notes.

This freshly brewed coffee has the main characteristics of a filter-like coffee with little crema, quickly disappearing (in less than 1 or 2 mins) to leave only a crown of crema around the cup. The result-in-cup is a coffee having a low body, little acidity, and little bitterness with absence of harsh, while being aromatic, soft, smooth, and sweet.

The average particle size “D4,3” represents the mean volume diameter of the coffee grind as obtained by laser diffraction method using a Malvern® optical instrument using an Aero S automated dry powder dispersion system to achieve the reproducible dispersion of powder samples over a wide size range.

The “fines” are considered as being coffee particles having a diameter of less than 90 microns when measured for example with a Malvern® or a Camsizer laser diffraction method.

A “stage” for grinding coffee in a grinder represents a pair of rolls.

The “delivery membrane” is meant to be the wall of the capsule from which the coffee is delivered comprising at least one beverage outlet provided after opening by any suitable method including cutting, puncturing and/or tearing or eventually a preformed beverage outlet.

The “granulometry” of the roast and ground coffee is defined as the diameter of the coffee particles as resulting after grinding as explained in the examples.

The “crema” is defined as the head of foam created on the coffee extract with a texture of substantially small bubbles. The crema attribute can be measured by an empirical sugar test which consists in arranging a well-defined crystal sugar layer, i.e., sugar of average particle size D4,3 of 660 microns on top of a freshly prepared cup of coffee and measuring the elapsing time between the start of overlaying and the main part of sugar's sinking. The “sugar test value” is thus a number of seconds.

As used in this specification, the words “comprises”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

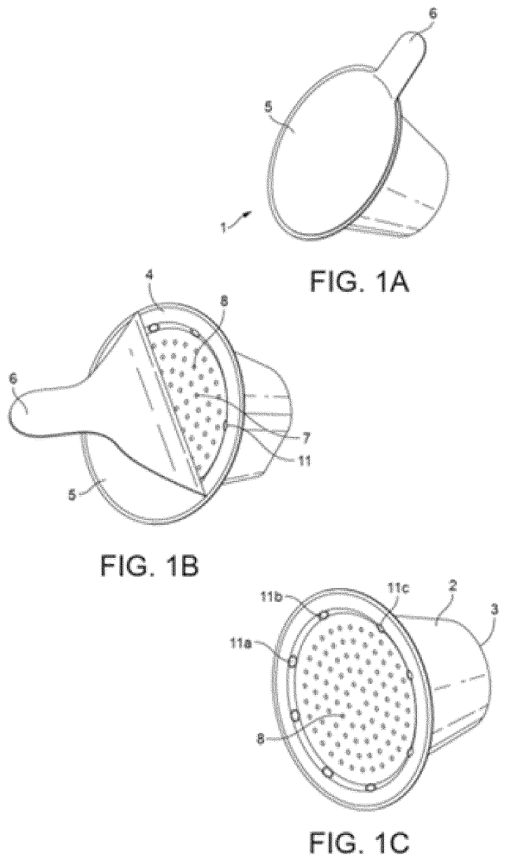

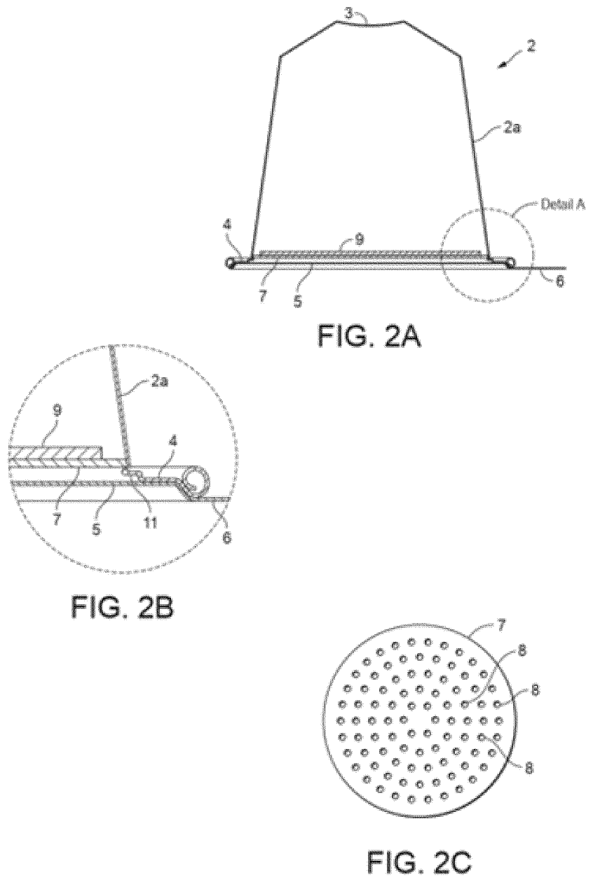

FIG. 1A shows a capsule 1 before use in a beverage preparation device, defined as storage state. Using the reference of FIGS. 2A and 2B, the capsule 1 of FIG. 1A, comprises a rigid capsule body 2. The body 2 comprises a frusto-conical sidewall 2a extending circumferentially around an inner space of the body. The capsule further comprises a rigid base wall 3 integral with the capsule body 2 closing off the inner space at a first end of the side wall of the capsule body 2. A flange 4 extends radially outwardly from a second end of the side wall of the capsule body 2a. At the second end of the side wall the capsule body 2 has an open filling side.

As usual, the capsule body 2 is processed to be food grade and comprises a lacquer layer or a polymer film layer (not represented) applied on the inside of the capsule body. The capsule body 2 may be Aluminium-based (aluminium, aluminium alloy), for example made of recycled aluminium, or the capsule body 2 may also be made of biodegradable and/or compostable material, for example it may be made of biodegradable polymer (like PLA, PHA . . . ) or it may be made of cellulose-based material (like paper or wood-pulp).

The capsule further includes a lid 5 that is attached to the flange 4 of the capsule body thereby closing hermetically the capsule. The lid 5 may be manually removed from the capsule by pulling on a free pull tab 6. In the present case, the pull tab 6 is integral with the lid 5 and protrudes from the lid but alternative solutions are available.

The lid 5 is a flexible sheet-like foil made of aluminum or any other suitable material, for example a compostable laminate comprising a barrier layer. The lid 5 comprises a heat-sealing lacquer layer or a polymer layer on the sealing side for its sealing on the flange 4 of the capsule.

In case the lid 5 comprises a lacquer layer on its sealing side, the thickness of the lacquer layer may be from 0.003 mm to 0.03 mm. In case the lid 5 comprises a polymer layer on the sealing side, the thickness of the polymer layer may be from 0.01 mm to 0.05 mm.

The lid 5 which is intended to be removed using the pull tab is attached to the flange 4 using an adhesive layer. The adhesive material is applied in the form of a layer of adhesive material and may be, for example, a layer of heat-seal lacquer or a polymer film layer.

As an example, the sealing layer forming the adhesive material may be a layer between 0.003 mm and 0.03 mm.

The layer of adhesive material allows removal of the lid 5 to the flange 4 of the capsule without any damage to the capsule 1.

The inner space of the capsule is filled with a beverage ingredient before the capsule is closed. In the present case, the capsule is filled with a coffee bed of roast and ground coffee before the capsule is tightly closed with the lid 5 to maintain freshness of the roast and ground coffee. The weight of the coffee is in the range of 4 g to 5.5 g for a capsule having the size of a conventional Nespresso® capsule. Depending on the size of the capsule, the weight of the coffee may be increased. However, tea, milk or chocolate ingredients may also be envisaged.

The capsule of FIG. 1B shows the capsule of FIG. 1A in which the lid 5 is partially removed by tearing the pull tab 6 and in FIG. 1C the same capsule in which the lid 5 is fully removed. As can be seen, the second end of the capsule (filling side) is no longer closed and presents on the inside of the capsule a membrane, defined as a carrier disk 7. The carrier disk 7 comprises multiple preformed outlet openings (or holes) 8 for the beverage (here coffee) prepared in the beverage preparation device. The capsule also comprises mechanical deformations 11a, 11b, 11c . . . , provided at the junction between the sidewall 2a and the flange 4 that retain the carrier disk 7 inside the inner space of the capsule. Four mechanical deformations 11 are visible in FIG. 1B. These mechanical deformations 11a, 11b, 11c . . . are also visible on the capsule of FIG. 1C, indeed eight mechanical deformations can be observed. These local deformations are made using a crimping process. Their function and the way they are done will be explained in connection with FIG. 2A and followings.

The preformed outlet openings 8 of the carrier disk 7 are covered by the lid 5 of the capsule thereby closing the capsule to keep hermetic sealing of the inner space of the capsule for ensuring freshness of the beverage ingredient inside the capsule during storage.

As will be seen in the cross-sectional views of the various embodiment of the capsule of the invention (see for example FIG. 2A), the capsule further comprises in its inner space a filter element 9 positioned between the coffee bed and the carrier disk 7. The filter element 9 prevent solid particles of the beverage ingredient, for example coffee particles or tea leaves, to flow out of the capsule inside the end-consumer cup during extraction.

The capsule body 2 and the lid 5 may be each mainly made from aluminum. However, as mentioned, other material may be envisaged for the capsule body and the lid.

For example, the capsule body and the lid may be made of plastic polymer material, or the capsule body and the lid may be made of cellulose-based material including paper.

As is understood, the capsule is extracted using a conventional high-pressure beverage preparation device compatible with conventional Nespresso® coffee capsules. The beverage preparation device comprises a fluid dispensing device capable of feeding an amount of a fluid, such as water, with a pressure between 0.1 bar and 20 bar to the capsule, and a brewing chamber, comprising a first part for holding the capsule and a second part for closing the brew chamber, the second part of the brewing chamber comprising an extraction plate presenting a tearing surface for engaging with the capsule at its second end opposite its base wall.

Summarizing a conventional extraction process of a closed capsule in the beverage preparation device: the capsule is inserted in the brewing chamber of the beverage preparation device. The fluid dispensing device feeds an amount of a fluid, such as water, to the capsule through the base wall 3 inside the capsule to make the coffee infused and then extracted. As pressure increases inside the capsule, the lid of the capsule comes into contact with the tearing surface of the extraction plate and the lid is altered by said tearing surface leading to the formation of opening which allows the coffee to flow out of the capsule.

The formation of the outlet openings at the surface of the lid is induced by interaction of the capsule lid with the tearing surface for the flow out of the coffee. The outlet openings contribute to the formation of foam and cream in the preparation process.

The use of conventional capsule (closed capsule) with the above-mentioned process leads to a coffee extraction at a pressure between 8 bar and 20 bar.

In the extraction process of a capsule, the lid of the capsule is removed before insertion of the capsule inside the brewing chamber of the beverage preparation device. The fluid dispensing device feeds an amount of a fluid, such as water, to the capsule through the base wall 3 inside the capsule to make the coffee infused and then extracted. The extracted coffee goes through the filter element 9 and then flows out through the outlet openings of the carrier disk 7. During extraction, the carrier disk 7 (which is at a distance from the flange of the capsule) has reduced into contact with the tearing surface of the extraction plate of the beverage preparation device (when compared to the contact between the lid of a conventional closed capsule and the tearing surface). The carrier disk 7 is thus less altered by the tearing during extraction of the capsule (as it is the case of a conventional extraction of a closed capsule where the capsule membrane is fully teared on the tearing surface of the extraction plate, as explained in the previous section).

The use of the capsule of the invention in a conventional beverage preparation device (like a Nespresso® machine) leads to a coffee extraction at a pressure between 1 bar and 6 bars, depending on the quantity of coffee inside the capsule and on the filter element structure.

Due to the fact that the lid is removed from the capsule before its use in the beverage preparation device and as the carrier disk is located inside the capsule (see FIG. 2A for example), the carrier disk is not intended to come into contact with the tearing surface of the extraction plate but in case it is, its deformation by said tearing surface is limited.

In more details, when preparing a coffee using a capsule 1 in a beverage preparation device, the user removes the lid 5 by tearing on the pull tab 6 before inserting the capsule in a beverage preparation machine. The base wall 3 of the capsule body 2 is further pierced and opened by piercing means of a beverage preparation device for supplying water under pressure into the capsule for the preparation of a coffee beverage.

As the capsule is not closed (lid 5 removed and outlet openings accessible) when used in the beverage preparation device, the extraction pressure building up inside the capsule is limited (1 to 6 bar) and there is limited formation of foam and cream during extraction.

Hence, because the pressure built up and the sudden pressure drop are not occurring (as with the use of conventional capsule), the interaction between the lid and the tearing surface of the extraction plate of the beverage preparation device is reduced, the resulting coffee in cup comprises little or no crema.

The capsule allows preparing crema-free coffee, tea, milk or chocolate depending on the beverage ingredient inside the capsule.

FIG. 2A shows a first embodiment of the capsule. As disclosed, the capsule comprises inside the inner space a carrier disk 7 comprising multiple preformed outlet openings 8 (i.e. a perforated carrier disk).

As presented on FIG. 2B, which is an enlarged and cross-sectional view of the identified bottom part portion of FIG. 2A, the carrier disk 7 is positioned inside the capsule at a distance from the lid 5 comprised between 0.1 mm to 2 mm, the lid 5 being sealed on the flange 4.

This gap between the capsule lid 5 (and so the flange 4 once the lid is removed for extraction) and the carrier disk 7 provides a recess so that if the carrier disk 7 flexes during the extraction process, the interaction with the tearing surface of the extraction plate of the beverage preparation device is reduced (when compared to a conventional capsule).

The carrier disk 7 may be a substantially round piece of material as shown in FIG. 2C, and its diameter is approximately the inner diameter of capsule at the location where the carrier disk 7 is positioned/inserted/maintained depending on the assembling process.

Hence, in the proposed embodiment, the diameter of the carrier disk 7 may be around 29.5 and 30.5 mm.

In the proposed embodiment, the carrier disk may be made of Aluminum. Its thickness may be about 0.3 mm but may vary between 0.1 mm and 1 mm.

The carrier disk may be made of aluminum and in a preferred solution, as the one presented in the figures, the capsule body, the lid, and the carrier disk are each mainly made from aluminum. However, other material may be envisaged.

In the presented solution, the carrier disk 7 is maintained inside the capsule thanks to local mechanical deformations 11 made on the capsule at the junction between the side wall 2a and the flange 4 of the capsule 1. In the detailed cross section of FIG. 2B, one mechanical deformation 11 is visible. The mechanical deformation is in the form of a crimping point 11 and is located on the side of the open side of the capsule, opposite the base wall 3.

As the capsule is made of a ductile material, preferably aluminum, the mechanical deformation by crimping allows reducing locally the diameter and thereby holding the carrier disk 7 (and filter) inside the capsule. The carrier disk is then retained inside the capsule 1.

Here, during the manufacturing process, the step of mechanically deforming the capsule at the junction of the flange 4 and sidewall 2a leading to the crimping points 11 is made on the capsule before closing the capsule with the lid 5.

The crimping points 11 (also visible on FIG. 1C), which are between 2 and 10 crimping points are angularly distributed on the perimeter of the open side of the capsule at the junction of the flange and sidewall of the capsule.

In view of the tooling that is used to make the crimping points, the crimping points 11 will preferably be equally distributed on the perimeter of the open side of the capsule.

Additionally, the crimping points 11 may have rounded crimping imprints according to the used crimping tool.

In an alternative way, the carrier disk 7 may be made of plastic or of a laminated membrane comprising for example, in polyolefins such as polypropylene, polyethylene or any other semi crystalline polymer. Preferably, the carrier disk 7 is biodegradable and/or compostable. Hence, the carrier disk 7 may be made of paper-based material, like a coated paper, a laminated paper or molded paper.

As can be seen on the FIG. 2C, the preformed outlet openings 8 may be circular openings homogeneously distributed on the surface of the carrier disk. This homogeneous distribution of the outlet openings with ensure a homogeneous flux of the coffee flowing out of the capsule 1. This also helps to avoid creation of channel with the beverage (coffee bed) inside the capsule.

The openings may have a diameter set around 0.75 mm to 1 mm, but the diameter may vary between 0.4 mm and 3 mm, most preferably between 0.5 mm and 1.3 mm.

The number of preformed outlet openings may vary depending on the size of the capsule (and on the size of the carrier disk) and on how fast the delivery of coffee is wished. In the disclosed embodiment, the carrier disk 7 comprises between 50 and 150 openings, preferably around 90 and in the presented embodiment around 100 outlet openings. In an alternative embodiment, the preformed outlet openings may be of oblong shape.

As presented, the capsule may further comprise a filter element 9 that during a possible assembling process is positioned on the ingredient bed (coffee bed for example) after the filling of the capsule, and the carrier disk 7 is positioned between the filter element and the lid 5. In an alternative assembling process, the filter is assembled onto the carrier disk and both elements are inserted into the capsule over the ingredient bed.

When the capsule is turned up-side down and as presented in the enlarged view of FIG. 2B, the filter element 9 lies on the carrier disk 7. The filter element is then supported by the carrier disk 7 inside the capsule. The filter is maintained flat inside the capsule and is not contacted by the tearing surface of the extraction plate of the beverage preparation device during extraction.

The use of a two-piece design may enable the use of none-sealable filter materials which could be an advantage for sustainability.

As proposed in this embodiment, the filter element 9 is circular with a smaller diameter than the diameter of the carrier disk 7, i.e. between 28 mm and 30.5 mm, and in general with 0.1 mm less than the disk carrier.

However, in an alternative embodiment, the diameter of the filter element 9 could be similar to the one of the carrier disk 7.

The filter element 9 may be made of non-woven material adapted to prevent/refrain coffee drains to go through too slowly or too quickly during extraction of the beverage with the aim to avoid creation of a crema layer and with the aim to avoid coffee drain going directly through the disk carrier to the cup.

The filter element 9 of the proposed embodiment may comprise a thickness between 20 to 300 microns, an air permeability in the range of 100 to 5000 l/m2/s according to ISO 9237, and a weight in the range of 5 to 600 g/m2. It may for example be a paper-based filter element.

The filter elements may comprise a layer of non-woven material connected by any known means to another filtering layer.

In the proposed embodiment of FIGS. 2A to 2C, the filter element 9 and carrier disk 7 are independent elements positioned on one another. However, they may be assembled together, for example by gluing or any other means. This will then change the assembling process in the capsule as the insertion of the filter and carrier disk will be made in one step. The filter element 9 and the carrier disk 7 may form together one part.

The proposed circular carrier disk 7 may have a tapered shape on its perimeter so as to fit (force fit) into capsules having truncated cone shape. However, other alternative shape and arrangement of the carrier disk inside the capsule may be envisaged.

It is preferred that the carrier disk 7 and filter element 9 remain in place inside the capsule when the lid 5 is removed and the capsule 1 extracted in the beverage preparation machine. Several assembling process may be considered and will be later on disclosed in connection with the proposed embodiments of the capsule.

In a variant embodiment that is not represented, the carrier disk may be made of plastic or of a laminated plastic element. In this configuration, the carrier disk is preferably, biodegradable and/or compostable. In this situation, the assembling process of the carrier disk in the capsule remains similar.

The inner space of the capsule body 2 is at least partially filled with ground coffee, preferably roast and ground coffee.

The granulometry of the ground coffee that is filled in the capsule has specific characteristics among which particle size distribution and specific level of fines. The granulometry of the coffee grounds shows a particle size distribution D4,3 of 500 microns+/−30 microns and a reduced fraction of fine particles F comprised between 2 and 9% of the roast and ground coffee. These values are quite unusual when dealing with coffee characteristics in conventional coffee capsules.

As known, the percentage of fines F is related to the measured range of particle size D4,3. When the particle size increases, the amount of fines usually inversely decreases. The finer the coffee is ground, the more fines are created.

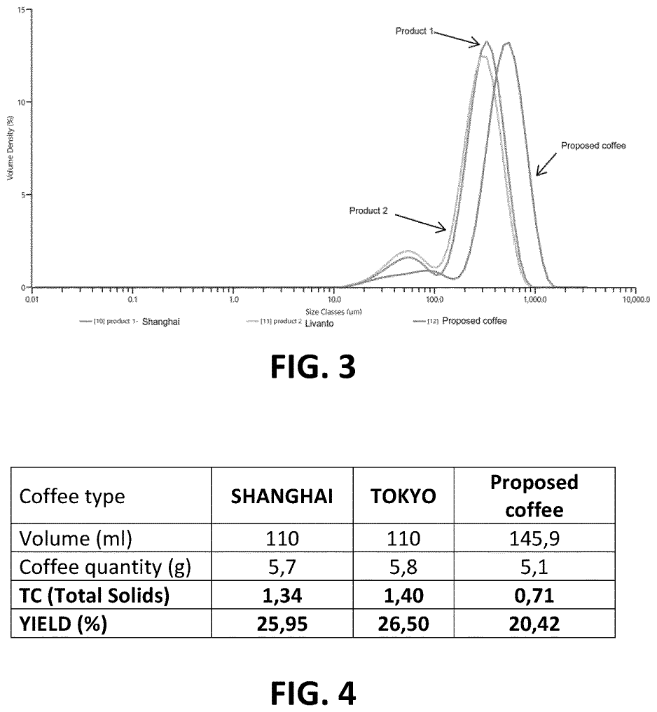

FIG. 3 shows a comparison of the roast and ground coffee particle size distribution between the proposed coffee capsule and the two commercial long cup coffees (proposed in closed capsules); Shanghai and Livanto respectively labeled as Product 1 and product 2 in FIG. 3.

The particle size distribution D4,3 and fines level F were determined by laser diffraction using a “Mastersizer v3.40” instrument from Malvern® equipped an Aero S automated dry powder dispersion system to achieve the reproducible dispersion of powder samples (1-2 g) over a wide size range. The complete experiment is repeated 3 times (or until the StDev<5%) and the results are averaged.

In the proposed capsule, the percentage of fines F is comprised between 2 and 9%, preferably between 5 and 8% when D4,3 is measured from 470 to 530 microns (μm).

When measured on FIG. 3, the D4,3 and percentages of fines values are presented in the following table.

| | Shanghai | Livanto | Proposed coffee |
|---|---|---|---|
| Product | (Product 1) | (Product 2) | product |
| D4, 3 (μm) | 306 | 279 | 506 |
| Fines % (F) | 12.0 | 14.7 | 7.2 |

As can be seen in the above table, the coffee particle size distribution of the proposed capsule is quite different from the ones of the commercial long cup capsules with a difference of at least 200 μm indicating that the coffee particles of the proposed coffee are grinded as coarse, optimizing the water flow rate through the capsule and reducing the extraction pressure, finally contributing to the filter-like coffee beverage profile.

Turning to the percentage of fine particles, the difference is also important between the proposed coffee and the coffee of the commercial long cup capsules. The difference is of at least 4.8% which indicate that the percentage of fines in the proposed coffee is importantly reduced, resulting in a reduced extraction pressure and an optimal flow rate of the hot water through the coffee bed.

The coarse particles size of the proposed coffee supposes that the surface of contact between the extraction fluid and the coffee particles is reduced and thus allows delivery of a light and smooth coffee extract characteristic of a filter-like coffee extract.

As an additional parameter of the proposed coffee product, the fines particles have an average diameter of less than 50 microns.

The amount of roast and ground coffee filled inside the capsule is between 4 and 5.5 grams, preferably between 4.8 and 5.3 grams. This coffee amount is a bit lower than the amount of coffee filled inside the conventional Nespresso® capsules (between 5 and 7 grams). This coffee amount between 4 and 5.5 grams is compatible with the technical characteristics of the capsule and with expected filter-type coffee extract attributes.

The ground coffee is filled loose in the capsule and has a density between 380 and 450 g/l, i.e., without compacting step before or after filling it in the capsule and ensures a certain amount of coffee is filled in the capsule. Alternatively, the coffee can be densified before the filling step using a densifying device. However, the coffee is not compacted in a solid block in the capsule but remains in a flowing state in the capsule.

The capsule is preferably filled with one single selected grinding having a selected particle size D4,3. In other words, two or more grindings having different particle sizes (D4,3) are not mixed for filling a capsule.

Due to its construction and to the type of coffee filled inside the capsule, the capsule has an internal pressure (stabilized pressure) between 5 and 100 mbars before being opened and used. The internal pressure applying in the proposed capsule is much lower than the one in the conventional Nespresso® capsules which is around 330 mbars. In fact, the internal pressure is limited to ensure an efficient sealing (to keep the coffee protected from moisture and oxidation) while still allowing easy removal of the lid by peel-off. The delamination of the lid during storage and/or transport is thereby avoided.

Although the key quality attributes are generally known for espresso-type coffee, there have been very little studies able to determine precisely a definition of a filter-like cup of coffee and corresponding consumers' preferences. For a filter-like coffee, key quality attributes can be determined by different means such as by consumer tests and focus groups.

Key quality attributes essentially encompass the extraction yield, the total solids and the presence and level of crema. While developing the proposed capsule and ground coffee to be filled in, it has been found that the extraction yield must preferably be maintained within a certain range. If the extraction yield is too high, the coffee is usually considered as bitter and harsh because non-desirable compounds may have been extracted over a too long time of extraction. Therefore, not only is it important to shorten the delivery of a filter-type coffee extract for the obvious reason of reduction of the waiting time but also a shorter delivery time tends to avoid the problems linked to the over-extraction of the coffee. Conversely, if the extraction yield is too low, the coffee tastes watery and is also not found acceptable by the average consumer.

It has been determined that an appropriate range of extraction yield is usually of from 15 to 30%, more preferably 17 to 28%, most preferably 18 to 22%.

Similarly, the amount of total solids TC in the cup must be sufficient to confer sufficient body and texture to the beverage otherwise the coffee tastes watery and does not find consumer acceptance. Therefore, although it may also be a matter of preference, the best concentration of total solids TC for a filter-type coffee extract has been determined to be within a range of from 0.3 to 1.5% wt, preferably between 0.35 and 0.9% wt. Proper extraction yields, and total solids can be obtained with capsules containing about 4 to 5.5 grams of coffee.

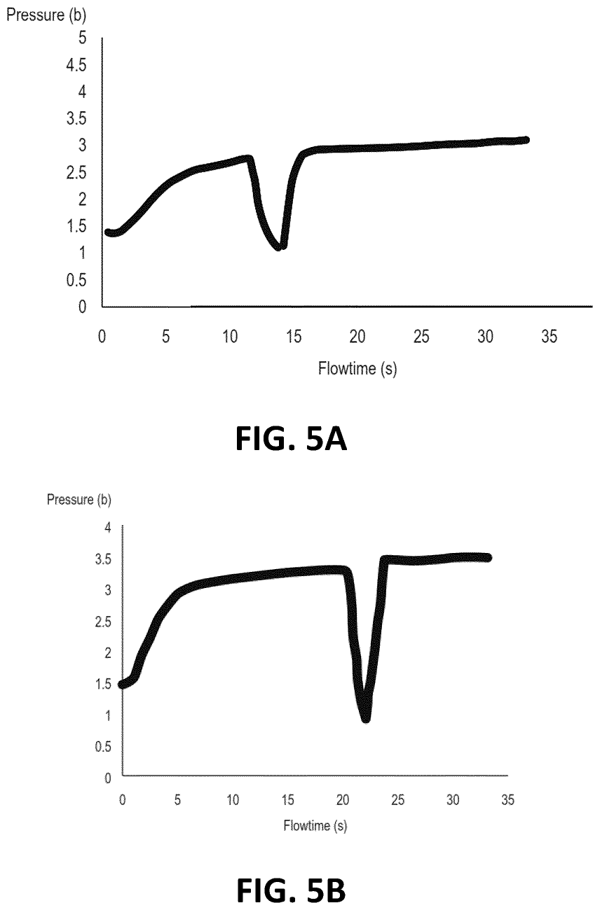

FIG. 4 shows a table comparing the TC and extraction yield between the proposed filter-type coffee (around 150 ml) and two long cup (110 ml) commercial Nespresso® coffees (Shanghai and Tokyo).

| Coffee type | SHANGHAI | TOKYO | Proposed coffee |
|---|---|---|---|
| Volume (ml) | 110 | 110 | 145.9 |
| Coffee quantity (g) | 5.7 | 5.8 | 5.1 |
| TC (Total solids) | 1.34 | 1.40 | 0.71 |
| YIELD (%) | 25.95 | 26.50 | 20.42 |

A comparison of these values shows a TC lower for the proposed coffee than for the two commercial references. This is fully in line with the expected results for the filter-type coffee extract that is expected to be light and smooth.

Hence, despite a reduced quantity of coffee (around 5 to 5.2 grams) inside the capsule and the low extraction pressure (2 to 6 bars), the proposed coffee allows obtaining a coffee extract having a good extraction yield (not far to the ones obtained with closed capsules) and a concentration of total solids TC in cup fully compatible with a filter-type coffee extract.

As previously described, within the proposed coffee capsule, the pressure loss in the coffee bed has been significantly reduced as compared to the pressure loss of the coffee bed in the (closed) capsules of the existing systems while at the same time providing a filter-like coffee extract having the desired coffee characteristics.

The presence of the filter element 9 and carrier disk 7 additionally contributes to a slow release of the pressure in the coffee bed during extraction and allows limiting the formation of crema-reduced crema being an important attribute of a filter-like coffee extract.

Additionally, the filter element allows retaining lipid fraction, preferably oils, from the coffee, before supplying the coffee extract to a container.

On top, thanks to the proposed capsule and extraction system, the filter-type coffee extract is delivered in a flow time of less than 40 s for a coffee extract volume of approximately 150 ml (without the needed relaunch time between the selected extraction sequence to obtain the 150 ml).

The reduced flow time is obtained thanks to the reduced level of fines in the roast and ground coffee of the proposed coffee which also contribute to the reduced flow time obtained for the extraction of a volume of approximately 150 ml.

The coffee extract may be obtained in one extraction when the machine allows a 150 ml extraction.

Alternatively, the coffee extract volume of 150 ml may be obtained by a double extraction using the same capsule. The double extraction comprises first extracting a lungo coffee extract to get a coffee extract of about 110 ml and then extracting an espresso coffee extract to get an additional volume of about 40 ml.

In a second alternative, it is possible to process a first espresso extraction and a second extraction by extracting a lungo coffee extract.

In any cases, whatever the chosen extraction sequence, the filter-type coffee extract of 150 ml is delivered in a flow time of less than 40 s without the relaunch time between the two extractions.

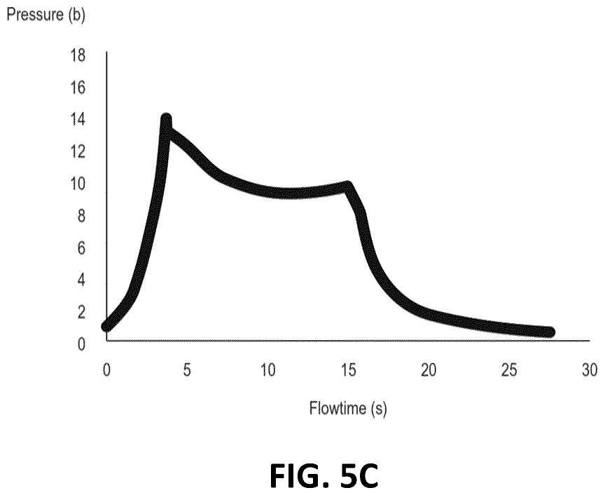

FIG. 5A and FIG. 5B show the evolution of coffee extraction pressure of the proposed capsule according to the above proposed double extraction process.

In FIG. 5A, the proposed capsule has been extracted on a Nespresso® machine, using first an espresso extraction and then a lungo extraction. As can be seen, the maximum extraction pressure remains below 3.5 bars and the total flow time is around 35 s. The pressure drop that can be seen around 15 s on the flow time axis is due to the end of the espresso extraction step before the lungo extraction step is started.

In In FIG. 5B, the proposed capsule has been extracted on a Nespresso® machine, using first a lungo extraction and then an espresso extraction. As can be seen, the maximum extraction pressure remains below 4 bars and the total flow time is around 35 s. The pressure drop that can be seen between 20 and 25 s on the flow time axis is due to the end of the lungo extraction step before the espresso extraction step is started.

In comparison, FIG. 5C shows the extraction pressure over time of a Nespresso® Roma commercial capsule on an Inissia® machine. As can be seen, the extraction pressure is comprised between 8 and 14 bars and the flow time of the coffee extract is around 25 to 30 S.

Thanks to the proposed capsule, it is possible to prepare a filter-like coffee extract having all the attribute of a filter-coffee, using a conventional Nespresso® machine in less than 45 seconds.

The foregoing description of one or more implementations provides illustration and description but is not intended to be exhaustive or to limit the scope of the invention to the precise form disclosed.

Hence, although the invention has been described by way of example, it should be appreciated that variations and modifications may be made in light of the above teachings or may be acquired from practice of various implementations of the present disclosure without departing from the scope of the invention as defined in the claims. Furthermore, where known equivalents exist to specific features, such equivalents are incorporated as if specifically referred in this specification.

1. A capsule for preparing a filter-type coffee extract, the capsule comprising:
a substantially rigid capsule body having a circumferential sidewall extending around an inner space of the capsule,
a base wall covering the inner space at a first end of the sidewall,
a flange arranged circumferentially at a second end of the sidewall of the capsule body,
a lid removably attached to the flange and covering the inner space at a second end of the sidewall opposite the base wall and tightly closing the capsule, and
a filter element positioned in the inner space of the capsule between the beverage ingredient and the lid,
wherein the inner space of the capsule is at least partially filled with ground coffee having a particle size distribution D4,3 of 500 microns+/−30 microns and a fraction of fine particles between 2 and 9% of the roast and ground coffee.

2. The capsule according to claim 1, wherein the fine particles have an average diameter of less than 50 microns.

3. The capsule according to claim 1, wherein the ground coffee inside the capsule is in an amount between 4 and 5.5 grams.

4. The capsule according to claim 1, wherein the ground coffee in the capsule has a density between 380 and 450 g/l.

5. The capsule according to claim 1, wherein the coffee extract is delivered in a flow time of less than 40 s for a coffee extract volume of 150 ml without any relaunch time between possible subsequent extractions.

6. The capsule according to claim 1, wherein the ground coffee inside the capsule is extracted at a pressure between 2 and 6 bars.

7. The capsule according to claim 1, wherein the capsule has an internal pressure between 5 and 100 mbars before being used.

8. The capsule according to claim 1, comprising wherein a carrier disk comprising multiple preformed outlets openings, provided between the lid and the filter element.

9. The capsule according to claim 7, wherein the carrier disk comprises between 50 and 150 outlet openings and an open surface ratio of the carrier disk that is higher than 4%.

10. The capsule according to claim 1, wherein the filter element has a porosity between 600 and 2500 l/m2/s according to ISO 9237 to retain fines inside the capsule.

11. The capsule according to claim 1, wherein the filter element retains lipid fraction from the coffee before supplying the coffee extract to a container.

12. The capsule according to claim 1, wherein the total solid (TC) in the resulting coffee extract is below 1.5%.

13. A system for preparing a beverage, the system comprising an exchangeable capsule and a beverage preparation machine with a fluid dispensing device capable of feeding an amount of a fluid with a pressure between 0.1 bar and 20 bar to the capsule, and with a brewing chamber,
the capsule comprising:
a substantially rigid capsule body having a circumferential sidewall extending around an inner space of the capsule,
a base wall covering the inner space at a first end of the sidewall,
a flange arranged circumferentially at a second end of the sidewall of the capsule body,
a lid removably attached to the flange and covering the inner space at a second end of the sidewall opposite the base wall and tightly closing the capsule, and
a filter element positioned in the inner space of the capsule between the beverage ingredient and the lid,
wherein the inner space of the capsule is at least partially filled with ground coffee having a particle size distribution D4,3 of 500 microns+/−30 microns and a fraction of fine particles between 2 and 9% of the roast and ground coffee,
wherein a coffee extract volume of 150 ml is obtained by a double extraction using the same capsule, the double extraction comprising
first, extracting a lungo coffee extract (110 ml) and second, extracting an espresso coffee extract (40 ml) or
first, extracting an espresso coffee extract (40 ml) and second, extracting a lungo coffee extract (110 ml),
the coffee extract being delivered in a flow time of less than 40 s without the relaunch time between the two extractions of the proposed extraction sequence.

14. (canceled)

15. A method for delivering a filter-like coffee extract from a capsule having a circumferential sidewall and a base wall defining an inner space and a removable lid closing the capsule at its opening side, by injection of water under pressure within the capsule using a beverage preparation machine,
wherein the inner space of the capsule is filled with a beverage ingredient such as ground coffee, preferably roast and ground coffee, and the inner space of the capsule hosts both
a filter element positioned in the inner space of the capsule between the beverage ingredient and the lid; and
a carrier disk comprising multiple preformed outlets openings, the carrier disk being provided between the lid and the filter element;
wherein the capsule, after removal of the lid, is inserted into and extracted by the beverage preparation machine;
wherein the coffee extract is released through the filter element and carrier disk with reduced engagement with engaging means of the beverage preparation machine in comparison of capsule comprising a non-removal lid; and
wherein the coffee extract is extracted at pressure between 2 and 6 bars.

16. The method according to claim 15 wherein during extraction, the pressure loss in the coffee bed is reduced by providing, in the capsule, roast and ground coffee having a particle size distribution D4,3 of 500 microns+/−30 microns and a fraction of fine particles between 2 and 9% of the roast and ground coffee.

17. The capsule according to claim 1, wherein the ground coffee comprises roast and ground coffee.

18. The capsule according to claim 1, wherein the lipid fraction retained by the filter element comprises oils from the coffee.

19. The capsule according to claim 1, wherein the total solid (TC) in the resulting coffee extract is between 0.3 and 0.9%.
